(19) United States
(12) Patent Application Publication
(10) Pub. No.: US 2017/0339669 A1
(43) Pub. Date: Nov. 23, 2017

(54) USER EQUIPMENT OF WIRELESS COMMUNICATION SYSTEM USING CARRIER AGGREGATION AND CARRIER AGGREGATION CONTROL METHOD FOR THE SAME

(71) Applicant: MEDIATEK INC., Hsinchu (TW)

(72) Inventors: Sheng-Yi HO, Su'ao Township (TW); Chao-Ming WU, New Taipei City (TW)

(21) Appl. No.: 15/159,267

(22) Filed: May 19, 2016

(51) Int. Cl. H04W 72/02; H04L 5/00; H04W 52/02; H04W 72/04

(52) U.S. Cl. CPC H04W 72/02; H04W 72/0453; H04L 5/001; H04W 52/0229

(57) ABSTRACT

A user equipment of a wireless communication system using carrier aggregation and a carrier aggregation control method thereof are provided. The user equipment includes an abnormal event detector and a processor electrically connected with the abnormal event detector. The abnormal event detector is configured to detect an abnormal event indicating that the user equipment is in an abnormal state. The processor is configured to control a component carrier of the wireless communication system in response to detecting the abnormal event. The carrier aggregation control method is applied to the user equipment to implement the operations.

### CROSS-REFERENCES TO RELATED APPLICATIONS

Not applicable.

### BACKGROUND OF THE INVENTION

### Field of the Invention

Aspects of the present disclosure are related generally to a wireless communication system using carrier aggregation, and more particularly, to a user equipment of the wireless communication and a carrier aggregation control method for the same.

### Descriptions of the Related Art

Demands for cellular transmission data are rapidly increasing as consumers use greater numbers of data intensive applications on their wireless data devices. This trend is encouraging wireless service providers to explore new ways of increasing data rates. One known method for increasing data rates employs carrier aggregation. Generally, carrier aggregation allows user equipment to simultaneously receive and/or transmit data using respective multiple frequency bands to improve throughput.

Typical architectures of carrier aggregation mostly specify that component carriers of a wireless communication system must be only controlled by a corresponding access network. In addition, the user equipment can only follow the control associated with the component carriers in principle. In other words, the user equipment cannot control component carriers of a wireless communication by itself under typical architectures of carrier aggregation. Unfortunately, such architectures will indicate that the user equipment cannot immediately remove bad effects which are introduced by carrier aggregation directly or indirectly. Even when carrier aggregation does not introduce bad effects to the user equipment, such architectures can affect the user equipment in effectively managing its resources for the carrier aggregation.

In view of this, it is important is to provide a solution in the art to enable user equipment to be capable of controlling component carriers by itself

### SUMMARY OF THE INVENTION

The following presents a simplified summary of one or more aspects to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present application is to provide a solution in the art to enable user equipment to be capable of controlling component carriers by itself To achieve the objective, one aspect of the present disclosure provides a user equipment of a wireless communication system using carrier aggregation. The user equipment may comprise an abnormal event detector and a processor electrically connected with the abnormal event detector. The abnormal event detector may be configured to detect an abnormal event indicating that the user equipment is in an abnormal state. The processor may be configured to control a component carrier of the wireless communication system in response to detecting the abnormal event.

To achieve the objective, one aspect of the present disclosure provides a carrier aggregation control method for a user equipment of a wireless communication system using carrier aggregation. The user equipment may comprise an abnormal event detector and a processor. The carrier aggregation control may comprise the following steps: detecting, via the abnormal event detector, an abnormal event indicating that the user equipment is in an abnormal state; and controlling, via the processor, a component carrier of the wireless communication system in response to detecting the abnormal event.

Other implement details and exemplary embodiments which are associated with the present disclosure will be apparent from the following description accompanied with the appended drawings. Also, it is understood that other aspects will become readily apparent to those of ordinary skill in the art from the following description accompanied with the appended drawings.

### BRIEF DESCRIPTION OF THE DRAWINGS

FIG. 1 is a block diagram conceptually illustrating an example of a wireless communication system according to one or more embodiments.

FIG. 2 is a schematic view conceptually illustrating an example of a carrier aggregation communication of the wireless communication system of FIG. 1 according to one or more embodiments.

FIG. 3A is a schematic view conceptually illustrating an example of controlling a component carrier in the user equipment of the wireless communication system of FIG. 1 according to one or more embodiments.

FIG. 3B is a schematic view conceptually illustrating another example of controlling a component carrier in the user equipment of the wireless communication system of FIG. 1 according to one or more embodiments.

FIG. 4 is a flow chart conceptually illustrating an example of a carrier aggregation control method for a user equipment according to one or more embodiments.

### DESCRIPTION OF THE PREFERRED EMBODIMENT

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those of ordinary skill in the art that these concepts may be practiced without these specific details. In some instances, well-known structures and components are shown in block diagram form to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication Systems (UMTS). 3GPP Long Term Evolution (LTE) and LTE-Advanced (LTE-A) are new releases of UMTS that use E-UTRA. UTRA, E-UTRA, UMTS, LTE, LTE-A and GSM; all of which are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE. LTE terminology is used in much of the description below.

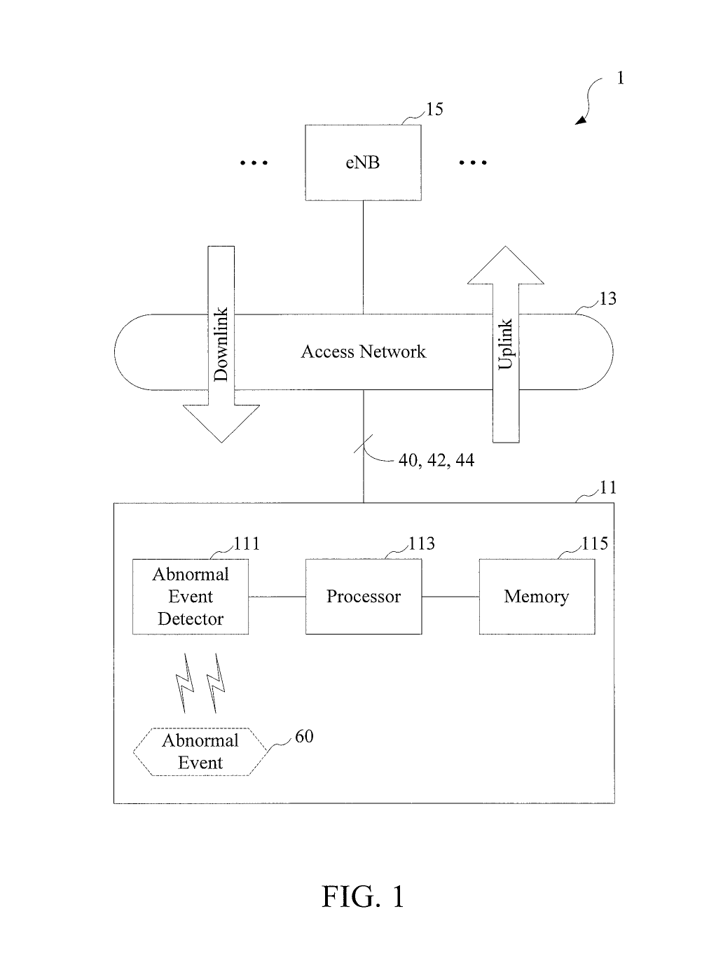

One aspect of the present disclosure provides a user equipment of a wireless communication system using carrier aggregation. FIG. 1 is a block diagram conceptually illustrating an example of the wireless communication system according to one or more embodiments. As shown in FIG. 1, a wireless communication system 1 is provided, which may be an LTE-based system for example. The wireless network 1 may include at least one eNB 15 (i.e., one or more eNBs) and at least one user equipment (UE) 11 (i.e., one or more UEs). Each eNB 15 may be a station that communicates one or more UEs 11 over an access network 13 (e.g., E-UTRAN) of the wireless communication system 1 and may also be referred to as a base station, a Node B, an access point, or other terminology.

Each eNB 11 may at least provide one communication coverage for one particular geographic area. In 3GPP, the term “cell” can refer to the coverage area of an eNB 15 and/or an eNB 15 subsystem serving this coverage area, depending on the context in which the term is used. Each eNB 15 may provide communication coverage for a macro cell, a pico cell, a femto cell, and/or other types of cell. A macro cell may cover a relatively large geographic area (e.g., several kilometers in radius) and may allow unrestricted access by UEs 11 with service subscription. A pico cell may cover a relatively small geographic area and may allow unrestricted access by UEs 11 with service subscription. A femto cell may cover a relatively small geographic area (e.g., a home) and may allow restricted access by UEs 11 with association to the femto cell (e.g., UEs in a Closed Subscriber Group (CSG), UEs for users in the home, etc.). An eNB 15 for a macro cell may be referred to as a macro eNB. An eNB 15 for a pico cell may be referred to as a pico eNB. An eNB 15 for a femto cell may be referred to as a femto eNB or a home eNB (HNB).

The wireless communication system 1 may be a heterogeneous network that includes eNBs 15 of different types, e.g., macro eNBs, pico eNBs, femto eNBs, relays, etc. These different types of eNBs 15 may have different transmission power levels, different coverage areas, and different impact on interference in the wireless communication system 1. The wireless communication system 1 may support synchronous or asynchronous operation. For synchronous operation, the eNBs 15 may have similar frame timing, and transmissions from different eNBs 15 may be approximately aligned in time. For asynchronous operation, the eNBs 15 may have different frame timing, and transmissions from different eNBs 15 may not be aligned in time. The techniques described herein may be used for both synchronous and asynchronous operation.

UEs 11 may be dispersed throughout the wireless communication system 1, and each UE 11 may be stationary or mobile. Each UE 11 may also be referred to as a terminal, a mobile station, a subscriber unit, a station, etc. Each UE 11, may be a cellular phone, a personal digital assistant (PDA), a wireless modem, a wireless communication device, a handheld device, a smartphone, a laptop computer, a cordless phone, a wireless local loop (WLL) station, or other mobile entities. Each UE 11 may be able to communicate with macro eNBs, pico eNBs, femto eNBs, relays, or other network entities.

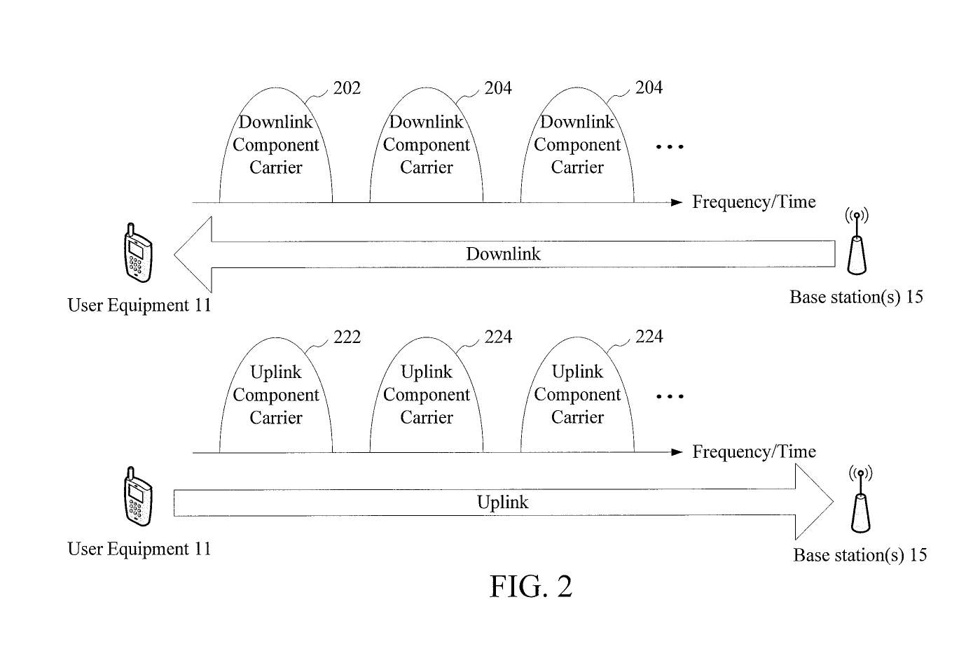

Carrier aggregation can be used in wireless communication system 1 according to LTE-Advanced to increase the bandwidth. In such a way, each UE 11 may use a spectrum in 20 MHz bandwidths allocated in a carrier aggregation of up to a total of 100 MHz (5 component carriers) used for transmission in uplink and downlink directions. Carrier aggregation can be used for both Frequency-division duplex (FDD) and Time-division duplex (TDD), and each aggregated carrier is referred to as a Component Carrier (CC); FIG. 2 can be referenced as an example.

FIG. 2 is a block diagram conceptually illustrating an example of a carrier aggregation communication of the wireless communication system 1 of FIG. 1 according to one or more embodiments. As shown in FIG. 2, carrier aggregation may include a primary serving cell (PCell) providing a primary component carrier (PCC) and one or more secondary serving cells (SCells) providing one or more secondary component carriers (SCCs) in each of the downlink transmission and the uplink transmission. For example, the downlink component carrier 202 may be the PCC in downlink transmission (DL-PCC), and the uplink component carrier 222 may be the PCC in uplink transmission (UL-PCC). In addition, one or more downlink component carriers 204 may be the SCC in downlink transmission (DL-SCC), and one or more uplink component carrier 224 may be the SCC in downlink transmission (UL-SCC).

All component carriers (i.e., one PCC and one or more SCCs) necessary for each of downlink transmission and uplink transmission can be provided by one single eNB 15 or by multiple eNBs 15. In other words, one eNB 15 itself can produce one or more cells providing one or more corresponding component carriers in downlink transmission and uplink transmission. One skilled in the art will recognize that procedures and methods applicable to the SCC and PCC may be applicable to the SCell and PCell, respectively. Likewise, one skilled in the art will recognize that procedures and methods applicable to the SCell and PCell may be applicable to the SCC and PCC, respectively.

The number of downlink component carriers and that of uplink component carriers can be identical or different. However, the number of uplink component carriers is always equal to or lower than the number of downlink component carriers. According to LTE-Advanced, two types of carrier aggregation methods have been proposed, i.e., contiguous carrier aggregation and non-contiguous carrier aggregation. The easiest way to arrange aggregation would be to use contiguous component carriers within the same operating frequency band (as defined for LTE), also known as intra-band contiguous. This might not always be possible due to operator frequency allocation scenarios. For non-contiguous allocation it could either be intra-band, i.e. the component carriers belong to the same operating frequency band, but have a gap, or gaps, in between, or it could be inter-band, in which case the component carriers belong to different operating frequency bands. The aggregation arrangement of downlink component carriers and that of uplink component carriers can be identical or different.

Those of ordinary skill in the art can readily learn other details and basics associated with various wireless communication system using carrier aggregation, such as LTE-Advanced system, as stipulated by the 3GPP, so the others are incorporated herein in its entirety by reference and will not be further described hereinafter.

With reference to FIG. 1, each UE 11 may include an abnormal event detector 111, a processor 113 and a memory 115 (optional element). The abnormal event detector 111, the processor 113 and the memory 115 may electrically connect with and communicate with each other directly, or via other medium(s) such as interfaces and buses indirectly. Each UE 11 may also include a wireless communication unit (not shown) electrically connected with the processor 113, such as a wireless transceiver with antennas, to communicate with the eNB(s) 15 over the access network 13 for the above-mentioned inter-communications therebetween.

Generally, carrier aggregation may bring various bad effects (such as the increase of temperature and power consumption) at a UE 11, because the UE 11 needs additional processes on more than one component carrier. When the UE 11 increases its power consumption due to carrier aggregation, its temperature always increases as well. To deal with various bad effects which are introduced by carrier aggregation or other events, and operations, etc., the abnormal event detector 111 is configured to detect an abnormal event 60 indicating that the UE 11 is in an abnormal state.

In one or more embodiments, the abnormal event detector 111 may include a temperature sensor which includes a thermal resistor or the like. A thermal resistor is a semiconductor device made of materials whose resistance varies as a function of temperature and can be used to compensate for temperature variation in other components of a circuit. With the characteristics of the thermal resistor, the temperature variation (especially for the increase of temperature) of the UE 11 can be sensed by the abnormal event detector 111. Once the sensed temperature exceeds a predetermined temperature threshold, the abnormal event detector 111 may detect an abnormal event 60 indicating that the UE 11 is in an undesired high temperature state.

In one or more embodiments, the abnormal event detector 111 may include a power consumption sensor which includes a power sensor or the like. A power sensor can be used to sense the power variation of all or part of the electronic elements disposed in the UE 11. Once the sensed power exceeds a predetermined power threshold, the abnormal event detector 111 may detect an abnormal event 60 indicating that the UE 11 is in an undesired power consumption state.

In one or more embodiments, the abnormal event detector 111 may include other known sensors in addition to the above-mentioned types to sense other abnormal events 60. In one or more embodiments, the abnormal event detector 111 may be replaced with a general event detector configured to detect various events including abnormal events and other events (e.g., common events).

The processor 113 is configured to control the component carrier of the wireless communication system in response to detecting the abnormal event 60. The processor 113 may include one or more processing units which can control all of the general operations and functions of a general purpose computer (e.g., UE 11). For example, the processor 113 may include one or more of the following: a central processing unit (CPU) which is the hardware within a computer that executes various programs; a microprocessor which is a CPU contained on a single integrated circuit (IC); a multi-core processor which is a single component with two or more independent CPUs (called “cores”) on the same chip carrier or on the same die; and a front end processor; and a helper processor for communication between a host computer and other devices.

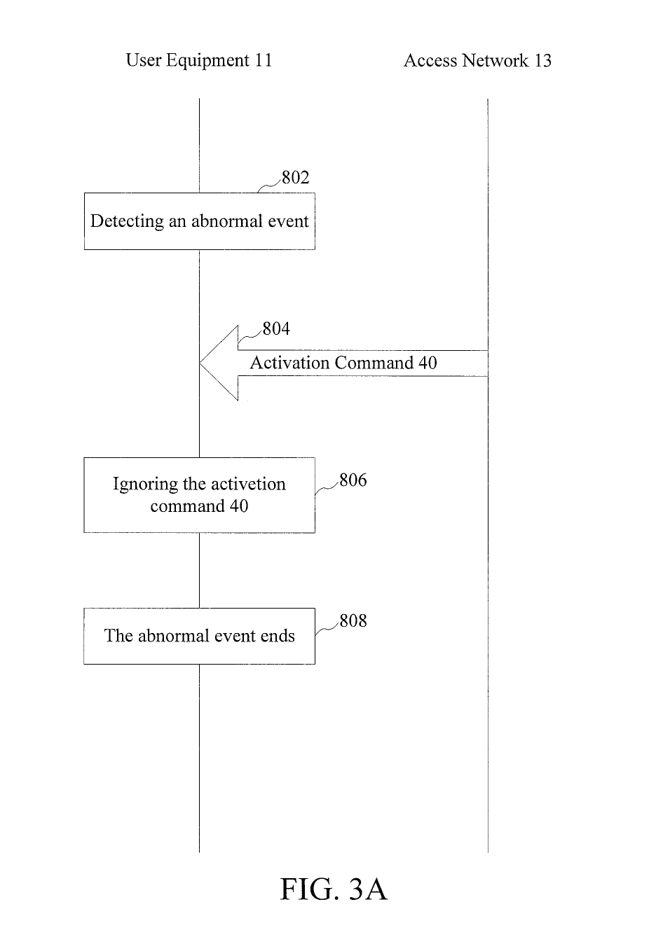

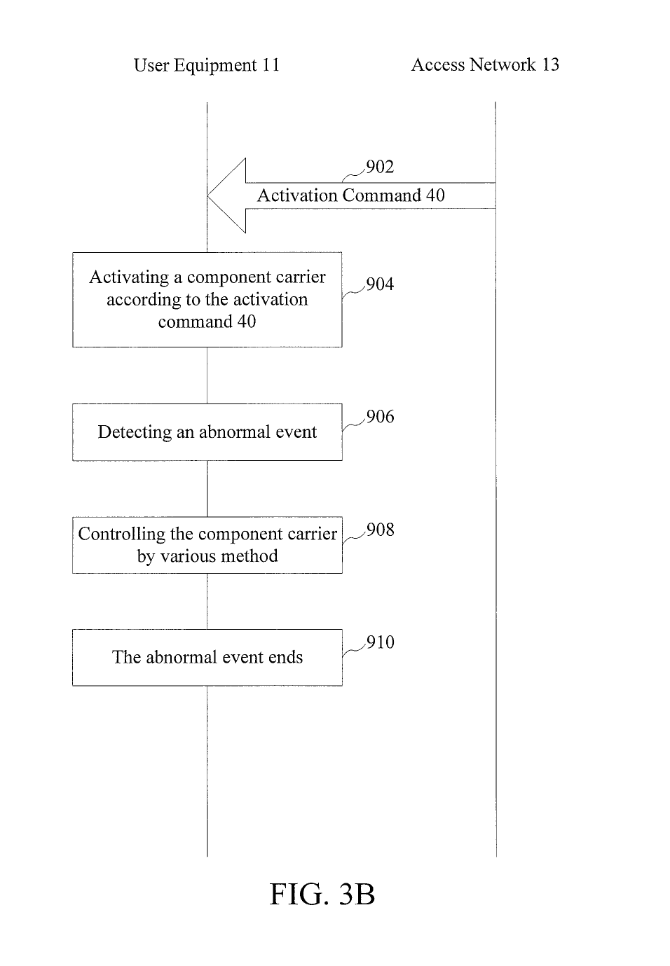

FIG. 3A is a schematic view conceptually illustrating an example of controlling the component carrier in the UE 11 of the wireless communication system 1 of FIG. 1 according to one or more embodiments. As shown in FIG. 3A, the processor 113 may ignore an activation command 40 associated with a component carrier from an access network 13 of the wireless communication system 1 if the activation command 40 is received after detecting the abnormal event 60 and during the abnormal event 60. More specifically, if the UE 11 receives an activation command 40 associated with a component carrier from the access network 13 of the wireless communication system 1 (indicated as 804) after the abnormal event detector 111 detects an abnormal event 60 indicating that the UE 11 is in an abnormal state (indicated as 802) and before the abnormal event 60 ends (indicated as 808), the processor 113 may ignore the activation command 40 (indicated as 806).

The activation command 40 is used to inform the UE 11 to activate the component carrier to the UE 11. The component carrier shown in FIG. 3A may be a PCC or a SCC. Sometimes, the unique PCC must be activated to keep the network-based communication between the UE 11 and each eNB 15 alive. Under the circumstances, it may be preferable that the processor 113 conditionally ignores an activation command 40 associated with a SCC and always accepts an activation command 40 associated with a PCC.

FIG. 3B is a schematic view conceptually illustrating another example of controlling the component carrier in the UE 11 of the wireless communication system 1 of FIG. 1 according to one or more embodiments. As shown in FIG. 3B, the processor 113 may control the component carrier in response to detecting an abnormal event 60 if the component carrier has been activated before detecting the abnormal event 60. More specifically, if the abnormal event detector 111 detects an abnormal event 60 indicating that the UE 11 is in an abnormal state (indicated as 906) after the access network 13 transmits an activation command 40 associated with a component carrier (indicated as 902) and the UE 11 has activated the component carrier according to the activation command 40 (indicated as 904), the processor 113 may control the component carrier in response to detecting an abnormal event 60 (indicated as 908) before the abnormal event 60 ends (indicated as 910).

In one or more embodiments, the processor 113 may deactivate the component carrier in response to detecting the abnormal event 60 (indicated as 908). In one or more embodiments, the processor 113 may keep the component carrier activated but does not use a corresponding downlink resource 42 allocated by the access network 13 of the wireless communication system 1 in response to detecting the abnormal event 60 (indicated as 908). In one or more embodiments, the processor 113 may keep the component carrier activated but does not use a corresponding uplink resource 44 allocated by the access network 13 of the wireless communication system 1 in response to detecting the abnormal event 60 (indicated as 908).

A downlink resource 42 may include various information and/or commands necessary for using a downlink component carrier such as time-slots, bandwidth, transmission, power, etc. Likewise, an uplink resource 44 may include various information and/or commands necessary for using an uplink component carrier such as time-slots, bandwidth, transmission, power, etc.

In one or more embodiments, the access network 13 may only limit the upper bound of uplink parameters (e.g., the uplink transport block (TB) size as stipulated in the specification of the 3G communication system) while the UE 11 can determine the actual values of the uplink parameters by itself within the limitation. Under the circumstances, the processor 113 may keep the component carrier activated but does not totally use a corresponding uplink resource 44 allocated by the access network 13 of the wireless communication system 1 in response to detecting the abnormal event 60 (indicated as 908). Likewise, the processor 113 may keep the component carrier activated but does not totally use a corresponding downlink resource 42 allocated by the access network 13 of the wireless communication system 1 in response to detecting the abnormal event 60 (indicated as 908).

The component carrier shown in FIG. 3B may be a PCC or a SCC. Sometimes, the unique PCC must be activated to keep the network-based communication between the UE 11 and each eNB 15 alive. Under the circumstances, it may be preferable that the processor 113 conditionally controls the SCC(s) and not always control the PCC.

In one or more embodiments, if a plurality of component carriers (i.e., more than one component carrier) of the wireless communication system 1 need to be controlled at the UE 11, the processor 113 may control the component carriers based on various communication conditions of the component carriers in response to detecting the abnormal event 60. The way in which the processor 113 controls each of the component carriers may be the same as shown in FIGS. 3A or 3B.

For example, the processor 113 may control the component carriers according to channel quality and/or the available time of the corresponding cells (or the eNBs 11). As shown in FIG. 3A, when a cell corresponding to a component carrier has a lower channel quality and/or fewer available times, the processor 113 may have higher priority to ignore an activation command 40 associated with the component carrier from an access network 13 of the wireless communication system 1 if the activation command 40 is received after detecting the abnormal event 60 and during the abnormal event 60. Likewise, as shown in FIG. 3B, when a cell corresponding to a component carrier has a lower channel quality and/or fewer available times, the processor 113 may have higher priority to control the component carrier in response to detecting an abnormal event 60 if the component carrier has been activated before detecting the abnormal event 60.

In one or more embodiments, the memory 115 is configured to store information associated with a component carrier which the access network 13 of the wireless communication system 1 provides during the abnormal event 60. The memory 115 may be a general purpose memory such as a volatile (i.e., RAM), a non-volatile (i.e., ROM and flash memory) or some combination of the two. The memory 115 may include but is not limited to: RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information.

Taking FIG. 3A as an example, the memory 115 may store all the information associated with the component carrier which the access network 13 provides during the abnormal event 60 (before the abnormal event 60 ends) even though the processor 113 may have ignored the activation command 40 associated with the component carrier from an access network 13. Taking FIG. 3B as another example, the memory 115 may store all the information associated with the component carrier which the access network 13 provides during the abnormal event 60 (before the abnormal event 60 ends) even though the processor 113 may have deactivated the component carrier or conditionally kept the component carrier activated as mentioned above.

With the memory 115, the UE 11 can immediately go back to the previous work stage that was subjected to various wireless communication systems using typical architectures of carrier aggregation when the abnormal event 60 ends. Note that the information stored in the memory 115 may include but is not limited to the following: cell switching control information (including activating and deactivating); cell uplink/downlink resource assignment information; and cell implicit release control information.

One aspect of the present disclosure provides a carrier aggregation control method for a user equipment (e.g., the UE 11 as shown in FIG. 1) of a wireless communication system (e.g., the wireless communication system 1 as shown in FIG. 1) using carrier aggregation. In this aspect, the user equipment may include an abnormal event detector (e.g., the abnormal event detector 111 as shown in FIG. 1), a processor (e.g., the processor 113 as shown in FIG. 1) and optionally include a memory (e.g., the memory 115 as shown in FIG. 1).

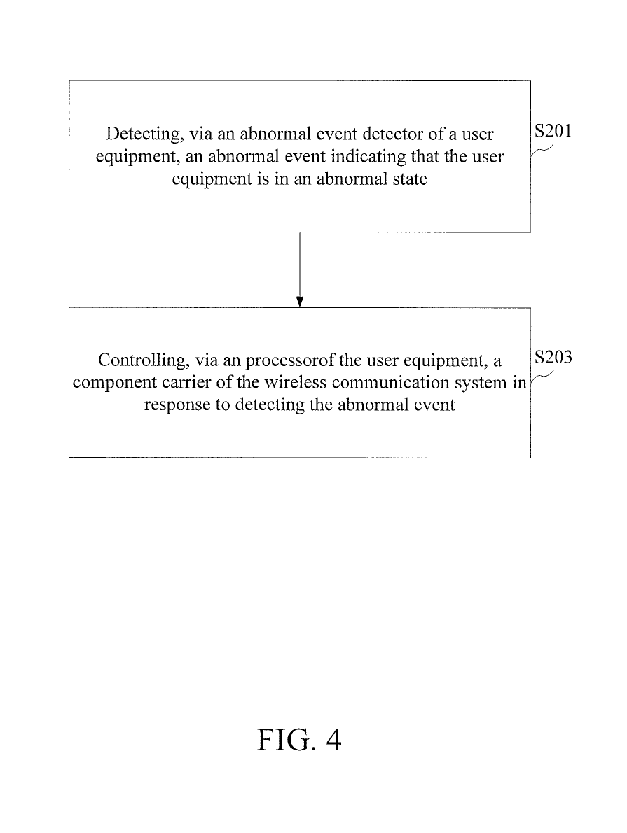

FIG. 4 is a flow chart conceptually illustrating an example of the carrier aggregation control method according to one or more embodiments. As shown in FIG. 4, the carrier aggregation control may comprise the following steps: detecting, via the abnormal event detector of a user equipment, an abnormal event indicating that the user equipment is in an abnormal state (indicated as S201); and controlling, via the processor of the user equipment, a component carrier of the wireless communication system in response to detecting the abnormal event (indicated as S203).

In one or more embodiments, the carrier aggregation control method may further comprise the following step: ignoring, via the processor, an activation command associated with the component carrier from an access network of the wireless communication system if the activation command is received after detecting the abnormal event and during the abnormal event.

In one or more embodiments, the step of controlling the component carrier (indicated as S203 in FIG. 4) of the carrier aggregation control method may comprise the following step: deactivating, via the processor, the component carrier in response to detecting the abnormal event if the component carrier has been activated before detecting the abnormal event.

In one or more embodiments, the step of controlling the component carrier (indicated as S203 in FIG. 4) of the carrier aggregation control method may comprise the following step: keeping, via the processor, the component carrier activated but not using a corresponding downlink resource allocated by an access network of the wireless communication system in response to detecting the abnormal event if the component carrier has been activated before detecting the abnormal event.

In one or more embodiments, the step of controlling the component carrier (indicated as S203 in FIG. 4) of the carrier aggregation control method may comprise the following step: keeping, via the processor, the component carrier activated but not using a corresponding uplink resource allocated by an access network of the wireless communication system in response to detecting the abnormal event if the component carrier has been activated before detecting the abnormal event.

In one or more embodiments, the step of controlling the component carrier (indicated as S203 in FIG. 4) of the carrier aggregation control method may comprise the following step: keeping, via the processor, the component carrier activated but not totally using a corresponding uplink or downlink resource allocated by an access network of the wireless communication system in response to detecting the abnormal event if the component carrier has been activated before detecting the abnormal event.

In one or more embodiments, the step of controlling the component carrier (indicated as S203 in FIG. 4) of the carrier aggregation control method may comprise the following step: controlling, via the processor, a plurality of component carriers of the wireless communication system based on communication conditions of the component carriers in response to detecting the abnormal event.

In one or more embodiments, the carrier aggregation control method may further comprise the following step: storing, via a memory of the user equipment, information associated with the component carrier which an access network of the wireless communication system provides during the abnormal event.

The carrier aggregation control method substantially comprises all the steps corresponding to all the operations of the disclosed user equipment above (e.g., the UE 11 as shown in FIGS. 1, 2, 3A and 3B). Because the steps of the carrier aggregation control method which are not described up to now can be readily understood by those of ordinary skill in the art according to the related content disclosed above, these steps will not be further described herein.

According to the above disclosure, the user equipment of wireless communications using carrier aggregation will be capable of controlling component carriers by itself. In such a way, the user equipment can immediately remove bad effects which are introduced by carrier aggregation directly or indirectly. Even when carrier aggregation does not introduce bad effects to the user equipment, the user equipment can still effectively manage its resources for carrier aggregation. Therefore, the problem that exists in the prior art has been overcome.

The previous description of the disclosure is provided to enable any person of ordinary skill in the art to make or use the disclosure. Various modifications to the disclosure will be readily apparent to those of ordinary skill in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein. Although such modifications and replacements are not fully disclosed in the previous description, they have been substantially covered in the following claims as appended.

What is claimed is:

1. A user equipment of a wireless communication system using carrier aggregation, comprising:
an abnormal event detector, configured to detect an abnormal event indicating that the user equipment is in an abnormal state; and
a processor, electrically connected with the abnormal event detector and configured to control a component carrier of the wireless communication system in response to detecting the abnormal event.

2. The user equipment as claimed in claim 1, wherein the processor is configured to ignore an activation command associated with the component carrier from an access network of the wireless communication system if the activation command is received after detecting the abnormal event and during the abnormal event.

3. The user equipment as claimed in claim 1, wherein the processor deactivates the component carrier in response to detecting the abnormal event if the component carrier has been activated before detecting the abnormal event.

4. The user equipment as claimed in claim 1, wherein the processor keeps the component carrier activated but does not use a corresponding downlink resource allocated by an access network of the wireless communication system in response to detecting the abnormal event if the component carrier has been activated before detecting the abnormal event.

5. The user equipment as claimed in claim 1, wherein the processor keeps the component carrier activated but does not use a corresponding uplink resource allocated by an access network of the wireless communication system in response to detecting the abnormal event if the component carrier has been activated before detecting the abnormal event.

6. The user equipment as claimed in claim 1, wherein the processor keeps the component carrier activated but does not totally use a corresponding uplink resource allocated by an access network of the wireless communication system in response to detecting the abnormal event if the component carrier has been activated before detecting the abnormal event.

7. The user equipment as claimed in claim 1, wherein the processor controls a plurality of component carriers of the wireless communication system based on communication conditions of the component carriers in response to detecting the abnormal event.

8. The user equipment as claimed in claim 1, further comprising a memory electrically connected with the processor, wherein the memory is configured to store information associated with the component carrier which an access network of the wireless communication system provides during the abnormal event.

9. A carrier aggregation control method for a user equipment of a wireless communication system using carrier aggregation, the user equipment comprising an abnormal event detector and a processor, the carrier aggregation control comprising the following steps:
detecting, via the abnormal event detector, an abnormal event indicating that the user equipment is in an abnormal state; and
controlling, via the processor, a component carrier of the wireless communication system in response to detecting the abnormal event.

10. The carrier aggregation control method as claimed in claim 9, further comprising the following step: ignoring, via the processor, an activation command associated with the component carrier from an access network of the wireless communication system if the activation command is received after detecting the abnormal event and during the abnormal event.

11. The carrier aggregation control method as claimed in claim 9, wherein the step of controlling the component carrier comprises the following step: deactivating, via the processor, the component carrier in response to detecting the abnormal event if the component carrier has been activated before detecting the abnormal event.

12. The carrier aggregation control method as claimed in claim 9, wherein the step of controlling the component carrier comprises the following step: keeping, via the processor, the component carrier activated but does not using a corresponding downlink resource allocated by an access network of the wireless communication system in response to detecting the abnormal event if the component carrier has been activated before detecting the abnormal event.

13. The carrier aggregation control method as claimed in claim 9, wherein the step of controlling the component carrier comprises the following step: keeping, via the processor, the component carrier activated but does not using a corresponding uplink resource allocated by an access network of the wireless communication system in response to detecting the abnormal event if the component carrier has been activated before detecting the abnormal event.

14. The carrier aggregation control method as claimed in claim 9, wherein the step of controlling the component carrier comprises the following step: keeping, via the processor, the component carrier activated but does not totally using a corresponding uplink resource allocated by an access network of the wireless communication system in response to detecting the abnormal event if the component carrier has been activated before detecting the abnormal event.

15. The carrier aggregation control method as claimed in claim 9, wherein the step of controlling the component carrier comprises the following step: controlling, via the processor, a plurality of component carriers of the wireless communication system based on communication conditions of the component carriers in response to detecting the abnormal event.

16. The carrier aggregation control method as claimed in claim 9, wherein the user equipment further comprises a memory, and the carrier aggregation control method further comprises the following step: storing, via the memory, information associated with the component carrier which an access network of the wireless communication system provides during the abnormal event.
